(19) United States
(12) Patent Application Publication
(10) Pub. No.: US 2024/0354638 A1
(43) Pub. Date: Oct. 24, 2024

(54) Named Entity Recognition System based on Enhanced Label Embedding and Curriculum Learning

(71) Applicant: Robert Bosch GmbH, Stuttgart (DE)

(72) Inventors: Bingqing Wang; Ishan Dindorkar, Indore (IN); Lars Franke, Untergruppenbach (DE); Zhe Feng, Mountain View, CA (US)

(21) Appl. No.: 18/303,885

(22) Filed: Apr. 20, 2023

(51) Int. Cl. G06N 20/00

(52) U.S. Cl. CPC G06N 20/00

(57) ABSTRACT

A system and method are disclosed for training a NER model configured to perform an NER task. The system and method advantageously utilize a label-word relation matrix to incorporate label semantic information into the attended text embedding. The system and method augment and enhance the design of the label-word relation matrix derived from label embeddings, which brings multiple benefits. In addition to the enhanced label-word relation matrix, the system and method further incorporate a novel training strategy that fits with the label embedding technique. With these improvements upon conventional NER systems, the system and method are effective for both open-domain and closed domain NER tasks.

### FIELD

The device and method disclosed in this document relates to machine learning and, more particularly, to named entity recognition using enhanced labeled embedding and curriculum learning.

### BACKGROUND

Unless otherwise indicated herein, the materials described in this section are not admitted to be the prior art by inclusion in this section.

The task of Named Entity Recognition (NER) is common and fundamental task in natural language processing (NLP) systems. NER is the process of annotating a span of text with predefined labels such as Person, Location, Organization, etc., which identify named entities in the span of text.

A recent trend in NLP systems is to leverage label embeddings. The labels are embedded in the same embedding space with the word embeddings. Thus, an attention mechanism can be introduced by measuring the relatedness/similarity between words and labels. Label embedding techniques with attention involved have been used in text classification systems, but not much in sequence labeling tasks, such as NER.

A first challenge in applying label embedding to the NER task is that the words related with a label are not necessarily the target named entity. Some of the most highly related words are synonyms of the labels, while many other related words appear in the target entity's context during pre-training. These highly related words become good indicating words, showing that the target named entity could appear nearby in the context. However, these related words also confuse the learning models into incorrectly apply the labels directly to the related words.

A second challenge in the NER task occurs when applying pre-trained model into a specific domain in which text is written with domain-specific terms. Such domain-specific terms will often confuse the model.

Finally, a third challenge in the NER task comes from the design of the labels used for the sequence labeling task. In a typical sequence labeling task, the labels are the compound combinations of an NER category and NER boundaries. For example, a typical NER category could include Person, Location, Organization, while the boundary is indicated by B (Begin), I (Intermediate), O (Out-of-scope), where the compound combination looks like B-Person, B-Location, I-Person, I-Location, etc. However, because the labels are compounded in this manner, the models do not learn whether an individual word contributes to boundary detection or entity type classification.

### SUMMARY

A method for training a model configured to perform a named entity recognition task is disclosed. The method comprises receiving, with a processor, a sentence and ground truth labels as training inputs. The method further comprises determining, with the processor, a text embedding representing the sentence using the model based on the sentence. The method further comprises determining, with the processor, an attention vector using the model using the model based on the text embedding. The method further comprises determining, with the processor, an attended text embedding using the model based on the text embedding and the attention vector. The method further comprises determining, with the processor, named entity recognition labels for individual words of the sentence using the model based on the attended text embedding. The method further comprises determining, with the processor, a first training loss based on the named entity recognition labels and the ground truth label data. The method further comprises refining, with the processor, the model using the first training loss.

### BRIEF DESCRIPTION OF THE DRAWINGS

The foregoing aspects and other features of methods are explained in the following description, taken in connection with the accompanying drawings.

FIG. 1 shows an encoder-decoder framework according to the disclosure.

FIG. 2 shows an exemplary embodiment of the computing device that can be used to train a named entity recognition model.

FIG. 3 shows a flow diagram for a method for training a NER model configured to perform an NER task.

FIG. 4 shows a formation of the label-word relation matrix.

FIG. 5 shows an augmentation of the original label-word relation matrix.

FIG. 6 shows a decomposition of the labels and the label-word relation matrix into three parts.

FIG. 7 summarizes the attention transfer mechanism in general terms.

FIG. 8 shows an approach in which a classification module is provided to make a pairwise difficulty comparisons for the purpose of sorting out the difficulty of all training sentences.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

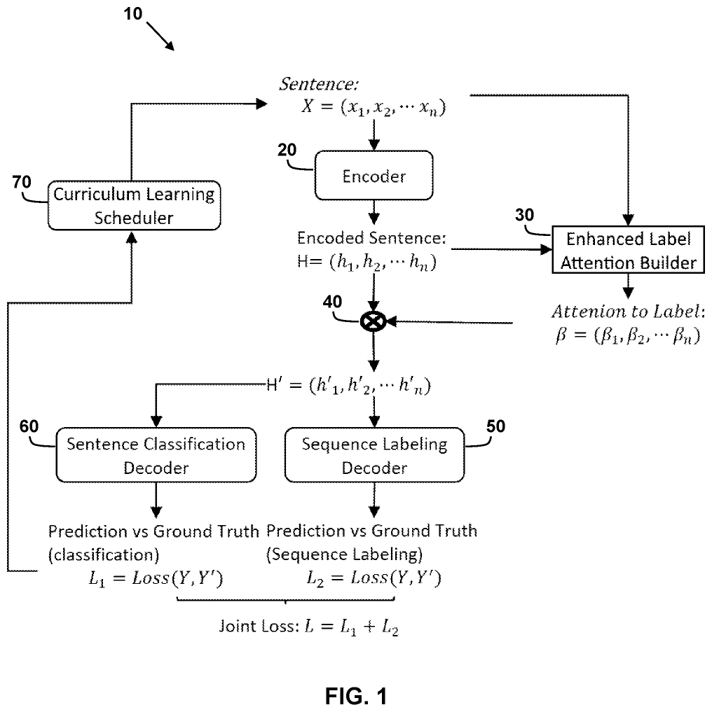

FIG. 1 shows an encoder-decoder framework 10 according to the disclosure, which may also be referred to herein as simply ‘the NER model.’ As shown in FIG. 1, in an encoding phase, first a sentence (i.e., a sequence of words X=(x₁, x₂, . . . , xₙ)) is fed into a text encoder 20 to generate sequence of hidden layer embeddings H=(h₁, h₂, . . . , hₙ), as referred to herein as the text embedding H. Then, the text embedding H is fed into an Enhanced Label Attention Builder 30, which determines an attention vector β=(β₁, β₂, . . . , βₙ) based on the text embedding H and a label-word relation matrix G, which is discussed in detail below. A multiplication element 40 determines an attended text embedding H′=(h′₁, h′₂, . . . , h′ₙ) based on the text embedding H and the attention vector β.

In a decoding phase, the encoder-decoder framework 10 adopts two decoders. An NER decoder 50 receives the attended text embedding H′ and determines token level NER labels for the sentence X. Likewise, a classification decoder 60 receives the attended text embedding H′ and determines a sentence level classification label that indicates whether the sentence X contains the entity or not. For training, the encoder-decoder framework 10 utilizes a first training loss L₁ determined with respect to the sentence level classification label and a second training loss L₂ determined with respect to the token level NER labels. The sum of the two training losses L₁ and L₂ is used to train the NER model jointly on both the classification and sequence labeling tasks.

It will be appreciated by those of ordinary skill that deep neural network models typically see challenges in low resource settings for the domain-specific tasks. The huge number of parameters in the layered deep neural network are difficult to train when there are few training instances available, which is typically the case in domain-specific applications. The encoder-decoder framework 10 addresses these problems by exploiting label semantics and label embedding, which is good resource for providing a direct link between text and labels.

As noted above, the encoder-decoder framework 10 utilizes a label-word relation matrix G to incorporate label semantic information into the attended text embedding H′. The encoder-decoder framework 10 augments and enhances the design of the label-word relation matrix G derived from label embeddings, which brings multiple benefits to an NER system. As will be discussed in greater detail below, a label attention transfer approach of the encoder-decoder framework 10 learns the rules to transfer the semantic emphasis from label-related words to target entity words, which is a novel approach to extend the application of label embedding from sentence level classification to token level NER task. The encoder-decoder framework 10 thus resolves the challenge of related words by transferring the relatedness of non-target words towards target named entities, based on the syntactic/dependency relations in the sentence, which aids the NER system in correctly recognizing the span of the target entities.

Additionally, the encoder-decoder framework 10 adopts a prior knowledge augmentation approach to synthesis label-label relations and word-word relations together with the label-word relation matrix G, which allows the NER system to integrate domain-specific knowledge into the named entity recognition process. The encoder-decoder framework 10 thus resolves the challenge of domain specific terminology by augmenting the label-word relations together with label-label relations and word-word relations, which is useful when the NER system is tasked to leverage the prior knowledge in a specific domain.

Finally, the label-word relation matrix G is further extended according to a decomposed label space, which helps to explain the behavior of the NER model in analysis. The encoder-decoder framework 10 thus resolves the challenge of compounded labels by representing the labels as basic entity types and boundary tags, and then constructing the compound NER label based on these entity types and boundary label. This allows the NER model to learn whether an individual word has contributed to boundary detection or to entity type classification, which further helps to interpret the behavior of the NER model.

In addition to the enhanced label-word relation matrix G, the encoder-decoder framework 10 further incorporates a curriculum learning scheduler 70 that implements a novel training strategy that fits with the label embedding technique. First, the curriculum learning scheduler 70 implements a curriculum learning strategy which contains a label-word relation matrix-based difficulty estimator and sampling-based training scheduler (SIS-SPL). The curriculum learning approach is utilized with the enhanced label embedding techniques. Curriculum learning has the philosophy of training the NER model from easy instances to difficulty instances, which mimics the behavior of the human learning process and has been shown to improve training efficiency. Label embedding provides a measurable way to calculate the relatedness of individual word to labels, which naturally can be applied further to rank the difficulty of training instances and re-arrange the batches of instances during the training process.

Moreover, a joint learning strategy is adopted to train the NER model jointly on both the classification and sequence labeling tasks, which helps to minimize false positive errors in the NER task, in which a text span without he named entity is falsely identified as named entity. This could happen due to a strong indicating word that is highly related with the label and falsely forces the NER model to extract the span in the wrong sentence.

With these improvements upon conventional NER systems, the encoder-decoder framework 10 is effective for both open-domain and closed domain NER tasks. The encoder-decoder framework 10 addresses the common challenges in NER systems and applications. Moreover, the encoder-decoder framework 10 even functions well in domain-specific applications, as it provides features to leverage domain specific prior knowledge and provides a convenient mechanism to measure the relatedness between text and labels.

### Exemplary Hardware Embodiment

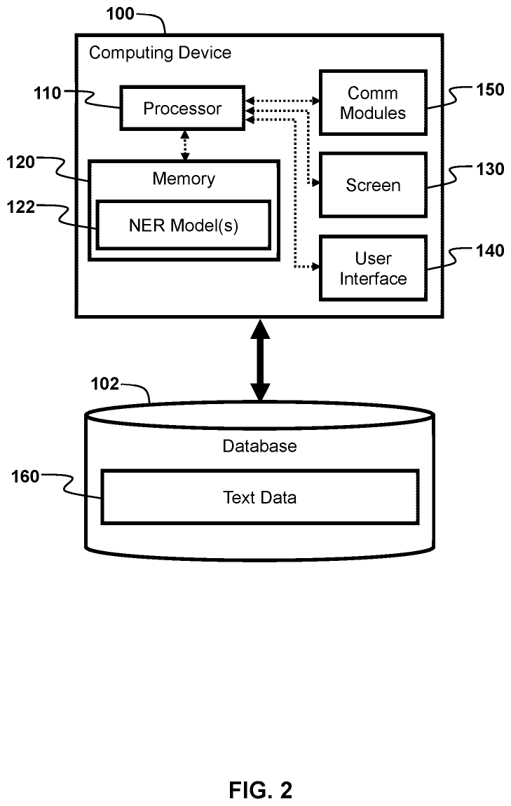

FIG. 2 shows an exemplary embodiment of the computing device 100 that can be used to train a named entity recognition (NER) model 122 for performing NER. Likewise, the computing device 100 may be used to operate a previously trained NER model 122 to perform NER on new text data. The computing device 100 comprises a processor 110, a memory 120, a display screen 130, a user interface 140, and at least one network communications module 150. It will be appreciated that the illustrated embodiment of the computing device 100 is only one exemplary embodiment is merely representative of any of various manners or configurations of a server, a desktop computer, a laptop computer, mobile phone, tablet computer, or any other computing devices that are operative in the manner set forth herein. In at some embodiments, the computing device 100 is in communication with a database 102, which may be hosted by another device or which is stored in the memory 120 of the computing device 100 itself.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of the named entity recognition (NER) model 122 that, once the training is performed, are configured to perform an NER task. In at least some embodiments, the database 102 stores a plurality of text data 160, which includes a plurality of training texts that are labeled with plurality of classification labels and sequence labels.

### Method of Training a Named Entity Recognition Model

A variety of operations and processes are described below for operating the computing device 100 to develop and train the NER model 122 for performing an NER task. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 or of the database 102 to perform the task or function. Additionally, the steps of the methods may be performed in any feasible chronological order, regardless of the order shown in the figures or the order in which the steps are described.

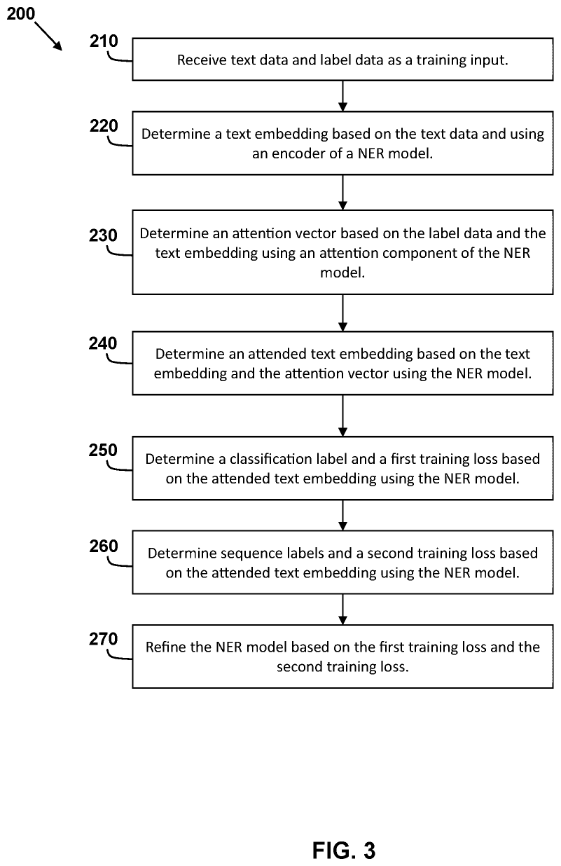

FIG. 3 shows a flow diagram for a method 200 for training a NER model configured to perform an NER task. The method 200 advantageously utilizes a label-word relation matrix G to incorporate label semantic information into the attended text embedding. The method 200 advantageously augments and enhances the design of the label-word relation matrix G derived from label embeddings. In addition to the enhanced label-word relation matrix G, the method 200 advantageously incorporates a novel training strategy that fits with the label embedding technique. With these improvements upon conventional NER methods, the method 200 is effective for both open-domain and closed domain NER tasks.

The method 200 begins with receiving text data and label data as a training input (block 210). Particularly, the processor 110 receives and/or the database 102 stores a plurality of labeled sentences. Each label sentence includes a sentence X in the form of a sequence of words (x₁, x₂, . . . , xₙ) and associated ground truth labels Y which includes token-level NER labels (y₁, y₂, . . . , yₙ)∈C, where n is the number of words and/or tokens in the sentence X and C is a set of pre-defined labels. In some embodiments, in addition to the token-level NER labels y₁, y₂, . . . , yₙ, the associated ground truth labels Y further includes a sentence level classification label y_{sentence} that indicates whether the sentence contains the entity or not. Alternatively, the processor 110 may determine a sentence level classification label for each sentence X from the token-level NER labels y₁, y₂, . . . , yₙ. In general, for reasons discussed below, the number of labeled sentences in the plurality of labeled sentences is small compared to the quantity that would be required to train conventional NER models. In this way, the training dataset can be constructed by manual labelling of sentences in a lower-resource setting and with lower costs.

The method 200 continues with determining a text embedding based on the text data and using an encoder of a NER model (block 220). Particularly, for each training sentence X, the processor 110 executes the text encoder 20 with the training sentence X as input to determine the text embedding H=(h₁, h₂, . . . , hₙ)∈ [symbol] ^{n×d}, where the token embeddings h₁, h₂, . . . , hₙ each comprise a vector representing a corresponding word or token from the training sentence X, d is the size of the embedding space (i.e., the length of each word embedding h). It should be appreciated that the text encoder 20 may take the form of an artificial neural network or any other suitable machine learning technique. In some embodiments, the text classification model 10 adopts, as the text encoder 20, the encoder part of a pre-trained and pre-existing language model.

The method 200 continues with determining an attention vector based on the label data and the text embedding using the NER model (block 230). Particularly, for each training sentence X, the processor 110 executes the Enhanced Label Attention Builder 30 to determine an attention vector β=(β₁, β₂, . . . , βₙ) based on the text embedding H and a label-word relation matrix G. The label-word relation matrix G represents relations between respective words in a vocabulary of N words and respective labels in a plurality of K labels. The label-word relation matrix G is generated prior to the training process of the method 200 but, in some embodiments, may be revised during the training process.

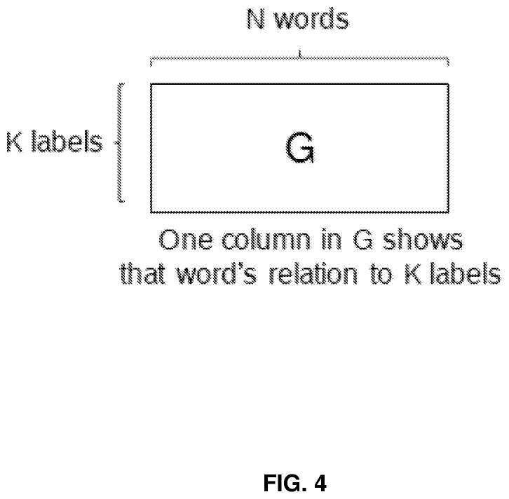

FIG. 4 shows a formation of the label-word relation matrix G. As can be seen, the label-word relation matrix G has dimensions R^{K×N} and each element g_{k,l} indicates a relation (or similarity) between respective word and a respective label. Each column in the label-word relation matrix G represents the corresponding word's relations to the plurality of labels.

To generate the label-word relation matrix G, the processor 110 first determines a plurality of word embeddings representing all N words in the vocabulary and determines a plurality of label embeddings representing all K labels in the plurality of labels. Particularly, suppose there are K labels (entity types in the NER task), which are fed into encoder 20 and mapped into the R^{d} embedding space, where d is the size of the embedding space. The label embeddings are denoted as:

$$C = ( {C}_{1} , {C}_{2} , … , {C}_{K} ) , {C}_{i} ∈ {R}^{d} .$$

Additionally, given a corpus of text data containing N unique words, each word is also fed into encoder 20 and mapped into the same embedding space R^{d}. The word embeddings are denoted as:

$$V = ( {V}_{1} , {V}_{2} , … , {V}_{N} ) , {V}_{i} ∈ {R}^{d} .$$

It should be appreciated that the processor 110 generates the word embeddings V by feeding all words in vocabulary into the encoder 20. This is in contrast to the generation of the text embedding H that was described above, in which a specific sentence X is fed into the same encoder 20. H represents a sequence of embeddings in a sentence X, while V represents all embeddings in the vocabulary.

Next, the processor 110 determines the label-word relation matrix G based on the plurality of word embeddings and plurality of label embeddings. Particularly, the processor 110 determines each element g_{k,l} in the label-word relation matrix G by determining a dot product of a respective word embedding Vₗ from the plurality of word embeddings and a respective label embedding Cₖ from the plurality of label embeddings. In some embodiments, the processor 110 normalizes each element in the label-word relation matrix G using a normalization operation. In one embodiment, the label-word relation matrix G is determined as follows:

$$G = norm ( {C}^{T} \cdot V ) , {g}_{k , l} = {C}_{k}^{T} \cdot {V}_{l} / ‖ {C}_{k} ‖ ‖ {V}_{l} ‖$$

C∈R^{d×K},V∈R^{d×N}→G∈R^{K×N},

where norm( ) is a function that performs an l₂ normalization operation on each element in the matrix G, as indicated in the equation for g_{k,l}.

In some embodiments, the label-word relation matrix G may be advantageously augmented using prior knowledge and expertise within the specific domain of the NER task. One difficulty of many NER tasks is that the domain-specific terms used in the domain are out of the general vocabulary of the NER model. In neural network-based models, the word embeddings of these out-of-vocabulary (OOV) words are difficult to estimate. Some of the OOV words are directly linked to the target named entity, which makes the NER task even more challenge in specific domain.

To handle the domain-specific challenges of the NER task, many existing NLP systems leverage domain-specific lexicon, which is composed of synonyms for that domain. For example, in automobile engineering field, a “Detection Time” and “Filter Time” of a network component are synonyms. Meanwhile, it is also the case that some labels are similar in their textual form, but different in the semantic meaning. Thus, the label embedding would look similar, which would also impact the final performance. For example, “recovery time” and “detection time” are both about time, but refer to different target entities.

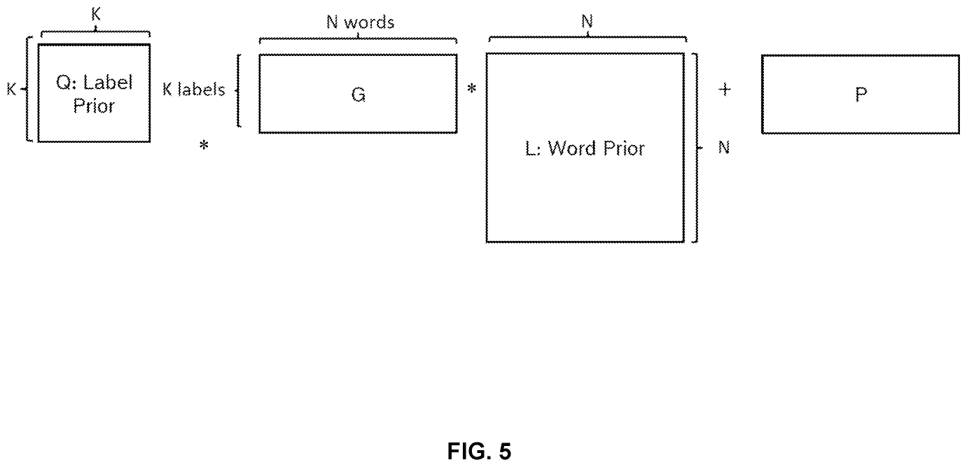

FIG. 5 shows an augmentation of the original label-word relation matrix G. Particularly, in some embodiments, the processor 110 augments the original label-word relation matrix G based on using prior knowledge and expertise within the specific domain of the NER task to address the challenges discussed above. The prior knowledge and expertise within the specific domain of the NER task can be embodied in one or more of a label-label relation matrix Q, a word-word relation matrix L, and a parameter matrix P. In this way, an augmented label-word relation matrix G′ leverages the domain-specific resource and incorporates the label and word relations in a unified approach. In one embodiment, the processor 110 determines the augmented label-word relation matrix G′ as follows:

$${G}^{′} = Q * G * L + P .$$

The label-label relation matrix Q has dimensions R^{K×K} and represents relations between labels in the plurality of K labels. Advantageously, the label-label relation matrix Q can be used to adjust the relations among the plurality of labels. Each element of the label-label relation matrix Q represents a similarity in meaning between a respective label from the plurality of K labels and a respective other label from the plurality of K labels. Usually, the number of labels is limited, e.g., less than 100, and their semantic similarity can be calculated either automatically, or be determined manually. For example, the value of each element can be determined as a dot product of the label embeddings of the respective label and the respective other label. Of course, there are many other ways to calculate the semantic similarity between labels. Given that there are many pretrained models, the system may adopt the appropriate label embedding given different contexts. The values of the elements are derived from prior knowledge and expertise within the specific domain of the NER task, for example by a domain expert or using a knowledge base. One typical application of the label-label relation matrix Q is that, for some labels that have similar textual form, but different semantic meaning, the label-label relation matrix Q can be used to manually enlarge the difference between these labels. Likewise, for some labels that have a similar semantic meaning, but a different textual form, the label-label relation matrix Q can be used to manually lessen the difference between these labels.

The word-word relation matrix L has dimensions R^{N×N} and represents relations between words in the plurality of N words. The word-word relation matrix L can be used to adjust the relations among the plurality of words using a domain-specific lexicon. Each element of the word-word relation matrix L represents a similarity in meaning between a respective word from the plurality of N words and a respective other word from the plurality of N words. For example, a value 1 may indicate that two words are synonymous and a value 0 may indicate that two words are completely unrelated or opposites. The values of the elements are derived from prior knowledge and expertise within the specific domain of the NER task, for example by a domain expert or using a knowledge base. Particularly, with a domain specific synonym lexicon, the matrix L can be configured to represent the word pair similarity in that specific domain.

Finally, the parameter matrix P has dimensions R^{K×N} and consists of arbitrarily adjustable parameters that can be used to make final adjustments on the augmented label-word relation matrix G′, thereby allowing other potential label-word information to be added to reform the original label-word relation matrix G.

In at least some embodiments, the plurality of K labels includes both compound and decomposed NER labels. Particularly, in NER tasks, the labels are typically designed as combination of an entity type and a label boundary. For boundaries, NER labels typically use B, I, and O (Begin, Intermediate, Out-of-Scope) to represent the boundary status, which is attached to an entity category, such as “Person”, “Location”, “Organization”, etc., to form a compound NER label. For example, a compound label “B-Person” means the beginning of a “Person” Entity, a compound label “I-Location” means the intermediate or ending position of a “Location” entity, and a compound label “O-Organization” means the word is out-of-scope with respect to an “Organization” entity.

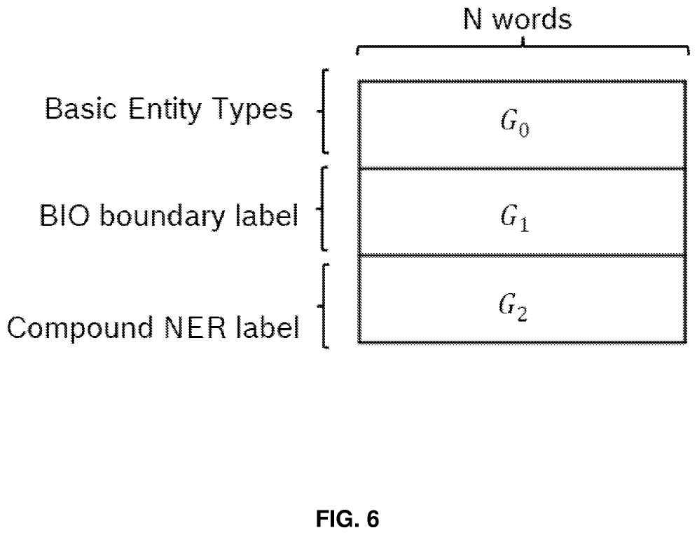

Thus, as shown in FIG. 6, the labels for an NER task can be decomposed into three parts: (1) the basic entity types, (2) the boundary BIO tags, and (3) compound label of entity type and boundary tag. More particularly, the plurality of K labels include (1) decomposed entity labels indicating named entity types, (2) decomposed label boundaries indicating label boundaries, and (3) compound labels each indicating both an entity type and a label boundary. By incorporating decomposed NER labels in the label-word relation matrix G, the NER model can learn the relationship between individual words and each of the three different types of labels.

As mentioned above, the label-word relation matrix G represents the relations between words and labels. From benchmark data, it can be observed that some words are good for boundary detection, for example, the verb “be”, on one hand, could indicate the beginning of certain types of entities, however, on the other hand, the verb “be” is too general to differentiate among different entity types. Another example comes from some adjectives, which don't necessarily help to detect the boundary of an entity, but can effectively differentiate the entity type. For example, in the phrase “knowledgeable and distinguished professor John Doe . . . ”, the word ‘knowledgeable’ usually describes a person entity, rather than a location or organization entity.

It should be remembered that the original label-word relation matrix G comes from the multiplication of label embeddings and the word embeddings. Thus, the embedding for basic entity types would are easy to acquire, which can be obtained by directly feeding the entity type text into the encoder. This corresponds to G₀ in FIG. 6. However, there is no embedding for “B I O” boundary tags. Accordingly, in some embodiments, the values of G₁ are initialized with as 1/n in G₁, where n is the number of different boundary tags (i.e., n=3 for “B I O” boundary tags). In at least some embodiments, as will be discussed in greater detail below, the values of G₁ are revised over time during the training process. Finally, the values for G₂ are determined as a synthesis of G₀ and G₁ (e.g., by summation or multiplication).

With the label-word relation matrix G/G′ generated, the processor 110 determines the attention vector β based on the text embedding H and the label-word relation matrix G/G′. As discussed above, the text embedding H is a sequence of word embeddings. The task here is to determine weights for each individual embedding h, or for each word. Thus, the attention vector β is designed to assign weight for each individual word contained in the sentence X.

The processor 110 determines the attention vector β as a sequence of attention values β₁, β₂, . . . , βₙ, each corresponding to a respective word in the sentence X. In one embodiment, each attention value βᵢ in the attention vector β is determined based on a subset of elements G[i] in the label-word relation matrix G/G′ at least representing relations between the respective word xᵢ and the plurality of K labels (i.e., a column from G corresponding to the i-th word xᵢ in the sentence X). In some embodiments, each attention value βᵢ in the attention vector β is determined based on a subset of elements G[i−r, i+r] in the label-word relation matrix G/G′ representing relations between the respective word xᵢ and the plurality of K labels and representing relations between at least one word adjacent to the respective and the plurality of labels (i.e., columns from G corresponding to a window of words around the i-th word xᵢ in the sentence X). In other words, at i-th position, the processor 110 gathers label relations from the label-word relation matrix G/G′ for the words in a context window [i−r, i+r].

In one embodiment, the processor 110 determines each attention value βᵢ in the attention vector β based an element in the label-word relation matrix representing a label in the plurality of K labels that has a strongest relation with the respective word xᵢ. In one embodiment, the processor 110 weights the subset of elements G[i−r, i+r] in the label-word relation matrix G/G′ with a weight matrix W. In one embodiment, the processor 110 offsets the subset of elements G[i−r, i+r] in the label-word relation matrix G/G′ by an offset matrix b. For example, the processor 110 may form the attention β as follows:

$${m}_{i} = max ( W \times G [ i - r , i + r ] + b ) , \\ β = ( {β}_{1} , {β}_{2} , … , {β}_{n} ) = softmax ( {m}_{1} , {m}_{2} , … , {m}_{n} ) .$$

In some embodiments, the attention vector β is advantageously modified depending on a pattern of words in the sentence X and/or a pattern of attention values in the attention vector β. As mentioned previously, label embedding is often seen in classification, but not much in sequential labeling tasks such as NER. One challenge is that a text span that has high relatedness with a particular label does not necessarily ensure that text span is the entity that is supposed to be labeled.

One typical example is the sentence: “The detection time is 100 ms.” The target named entity to be labeled in the sentence is “100 ms,” which is the concrete value for a “Detection Time” named entity label. Typically, named entity labels represent abstract concepts, while the target entities that are to be labeled with the named entity label are concrete words or phrases. As in the example, a sentence may include words describing the abstract concept behind the named entity label (i.e., “The detection time is”), as well as concrete values or phrases for the named entity label (i.e., “100 ms”). In the example, the leading words “The detection time is” will have high relatedness with the “Detection Time” named entity label, while the concrete value “100 ms” might have less relatedness.

In some embodiments, the processor 110 advantageously modifies the attention vector β to transfer attention from the label related words of the sentence X to the target entity words of the sentence X, according to one or more known linguistic patterns that can be detected in the sentence X and/or the attention vector β. For example, the example sentence discussed above has the pattern:
LABEL_RELATED_WORDS [is] TARGET_ENTITY,
   where LABEL_RELATED_WORDS indicates one or more words in the sentence X that have corresponding attention values in the attention vector β that exceed a predetermined threshold and TARGET_ENTITY indicates one or more words in the sentence X that are expected to be labeled with the particular named entity label. The LABEL_RELATED_WORDS and the TARGET_ENTITY are connected with the predicate “is” or “be.” The pattern is, thus, defined by the positional relationship between the LABEL_RELATED_WORDS and the TARGET_ENTITY within a sentence.

Using the pattern, the processor 110 transfers attention from the LABEL_RELATED_WORDS to the TARGET_ENTITY. In other words, the processor 110 modifies the attention vector β to reduce the attention values corresponding to the LABEL_RELATED_WORDS and increases the attention values corresponding to the TARGET_ENTITY. As applied to example sentence, the attention is transferred as follows:
The detection time is 100 ms→The detection time is 100 ms,
   where the underlined words indicate words having high attention values before and after the attention transfer.

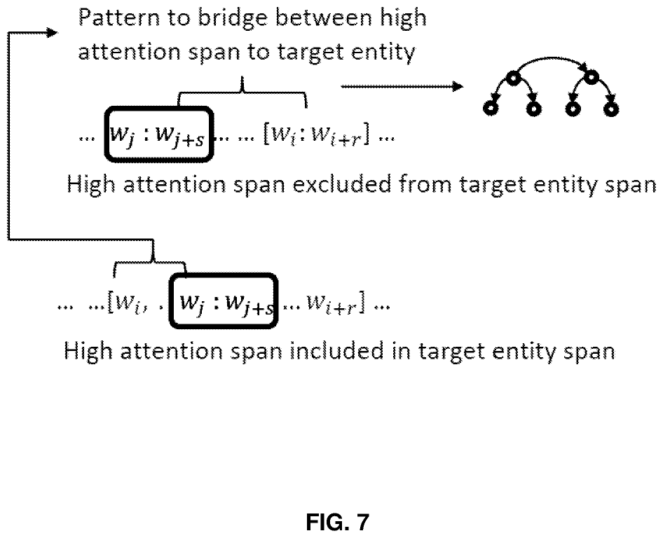

FIG. 7 summarizes the attention transfer mechanism in general terms. The processor 110 first identifies the text span that has high label attention based on the attention vector β=(β₁, β₂, . . . , βₙ), where βᵢ represents the i-th word's attention(relatedness) to target label. Then, as shown in FIG. 7, the processor 110 identifies the pattern between the high attention text span (i.e., LABEL_RELATED_WORDS) and the target entity span. Typically, the high attention span is either excluded from or included in the target entity span (i.e., TARGET_ENTITY). The text patterns for bridging the spans or a path between the text span over a parsing tree can be learned.

For the purpose of pattern detection, given the k-th label, there would be many patterns that can be extracted by comparing the high attention span and the target entity span. In one embodiment, the processor 110 selects top ranking patterns, where the ranking score can be calculated by pointwise mutual information family, as follows:

$${pmi}^{t} = {log}_{2} \frac{{p ( x , y )}^{t}}{p ( x ) p ( y )}$$

P(x, y) represents the joint distribution between two random variables, where here it can refer to the joint distribution of a pattern and the k-th label. p(x) and p(y) represents the possibility to observe the pattern alone and the possibility to observe the k-th label alone. Parameter t is a parameter to control the value. In some notations, pmi^{t} may also denoted as pmi^{k}. In order to not get confused with k-th label notation, t is used here to denote the power parameter over p(x, y).

Here, there could be many variants on the ranking approach of the patterns. In some embodiments, for example, in low resource learning settings where only a few or very few training instances are given, a data augmentation approach is utilized, such as a Bootstrapping approach. The bootstrapping approach follows the iteration scheme: entity->pattern->entity->pattern. In each iteration, entities help to find patterns, and pattern will be used to identify more potential entities, or in other terms “weak labels”. After a few iterations, the approach would generate a set of patterns linking the label-related words to the target entities.

Returning to FIG. 3, the method 200 continues with determining an attended text embedding based on the text embedding and the attention vector using the NER model (block 240). Particularly, for each training sentence X, the processor 110 executes the multiplication element 40 to determine an attended text embedding H′=(h′₁, h′₂, . . . , h′ₙ) based on the text embedding H and the attention vector β. The processor 110 determines the attended text embedding H′ as follows:

$${H}^{′} = ( {h}_{1}^{′} , {h}_{2}^{′} , … , {h}_{n}^{′} ) = ( {β}_{1} {h}_{1} , {β}_{2} {h}_{2} , … , {β}_{n} {h}_{n} ) ,$$

wherein the attention values βᵢ operate as weights on the word embeddings hᵢ to arrive a sequence of attended word embeddings h′ᵢ.

The method 200 continues with determining a classification label and a first training loss based on the attended text embedding using the NER model (block 250). Particularly, for each training sentence X, the processor 110 executes the classification decoder 60 to determine a sentence-level classification label y′_{sentence} for the sentence X as a whole. It should be appreciated that the classification decoder 60 may take the form of an artificial neural network or any other suitable machine learning technique.

The sentence-level classification label y′_{sentence} may be a simple binary classification, indicating whether the sentence X contains any type of the target entity type or it completely contains no target entity. Alternatively, the sentence-level classification label y′_{sentence} may be multi-class classification, where the K entity types would correspond to 2K sentence-level classification labels, indicating whether the sentence X contains each target entity type or does not contain each target entity type.

Additionally, for each training sentence X, the processor 110 executes the classification decoder 60 to determine a training loss L₁ according to:

L₁=Loss(Y,Y′),

wherein Y′ includes the sentence-level classification label(s) y′_{sentence}, Y includes ground-truth sentence-level classification label y_{sentence} from the label data received with the training sentences X, and Loss( ) is a suitable loss function.

The method 200 continues with determining sequence labels and a second training loss based on the attended text embedding using the NER model (block 260). Particularly, for each training sentence X, the processor 110 executes the NER decoder 50 to determine token-level NER labels (y′₁, y′₂, . . . , y′ₙ)∈C for individual words of the sentence X. It should be appreciated that the NER decoder 50 may take the form of an artificial neural network or any other suitable machine learning technique.

Additionally, for each training sentence X, the processor 110 executes the NER decoder 50 to determine a training loss L₂ according to:

L₂=Loss(Y,Y′),

where Y′ includes the predicted token-level NER labels (y′₁, y′₂, . . . , y′ₙ), Y includes ground-truth token-level NER labels (y₁, y₂, . . . , yₙ) from the label data received with the training sentences X, and Loss( ) is a suitable loss function.

The method 200 continues with refining the NER model based on the first training loss and the second training loss (block 270). Particularly, during each training cycle and/or after each batch of sentences X, the processor 110 refines one or more components of the NER model based on the training losses L₁ and L₂. The one or more components of the NER model that are refined may include any or all of the text encoder 20, the Enhanced Label Attention Builder 30, the NER decoder 50, and the classification decoder 60.

In at least some embodiments, during such a refinement process, the model parameters (e.g., model coefficients, machine learning model weights, etc.) of the NER model are modified or updated based on the training losses L₁ and L₂ (e.g., using stochastic gradient descent or the like). In some embodiments, the processor 110 combines the training losses L₁ and L₂ by summation as follows:

$$Joint Loss : L = {L}_{1} + {L}_{2} ,$$

and the processor 110 refines the components of the NER model based on the joint loss L.

The NER model is thus trained using a joint learning approach. One problem in NER tasks, especially in low resource settings, is that the training is prone to overfitting, which might cause the trained model identify wrong entities in irrelevant sentences that should not have any target entities. The method 200 tackles this issue by learning the NER task together with a classification task in which the sentences as a whole is annotated to indicate whether the sentence contains the target entity or not.

In some embodiments, values of the label-word relation matrix G/G′ are similarly modified or updated based on the training losses L₁ and L₂. In some embodiments, during the training phase, the parameter updates in G₀ and G₁ do not have the same cycle. The values in G₀ can be considered relative stable and, thus, in some embodiments, are only adjusted every several batches of training sentences X. After several batches of training instances, the processor 110 updates the parameter in G₀, since G₀ relies on the encoder 20, whose parameters may be constantly updated in the training. Meanwhile, in some embodiments, the processor 110 updates the values in G₁ at a comparatively faster pace. In one embodiment, the values in G₁ are be updated in each back-propagation process given a batch of training sentences X. Finally, in some embodiments, the processor 110 updates the values in G₂ with same update cycle as with G₁, since G₂ can be considered a synthesis of G₀ and G₁.

The training process of the method 200 is repeated for each sentence in the plurality of sentences X. The processor 110 schedules the plurality of sentences X into an ordered sequence of sentences for training the NER model. In some embodiments, the plurality of sentences X are sequenced by the curriculum learning scheduler 70 according to a curriculum learning technique in which sentences having a relatively lower NER difficulty are sequenced earlier than sentences having a relatively higher NER difficulty. During the overall training process, the processor 110 feeds the plurality of sentences X to the NER model according to the ordered sequence. In other words, the training sentences are provided in an order depending on their difficulty, usually from easiest training sentences to the hardest sentences.

A curriculum learning approach enables the NER model to be more effectively trained. This approach imitates a human's learning process, who first learns the easy instances and then progressed to hard instances. Current curriculum learning is mainly composed of two components: (1) a difficulty estimator and (2) a training scheduler. The difficulty estimator is configured to sort all the training instances by their difficulty. The training scheduler is configured to organize the composition of each batch of training instances. Each batch of training instances are composed of easy instances and difficult instances, while a ratio between easy and difficult training instances in each batch is dynamic in the training process. With the progress of training, in each batch, more difficult instances will be used for training.

In some embodiments, the processor 110 determines, for each respective sentence X in the plurality of sentences X, a respective NER difficulty using the label-word relation matrix G. The NER difficulty indicates a difficulty of performing the NER task with respect to the respective sentence X. For the difficulty estimator, the processor 110 advantageously incorporates the label-word relation matrix G into the process of difficulty estimation. As introduced above, the label-word relation matrix G represents the relatedness between individual words and individual labels. The label-word relation matrix G and the derived attention vectors β are natural tools for estimating the difficulty of a particular training sentence X.

In one embodiment, the processor 110 estimates the NER difficulty for a particular training sentence X as follows:

$$D = norm ( {\sum }_{i - r}^{j + r} ( {α}_{i} \cdot G [ i , j ] + {φ}_{i} ) ) = [ \begin{matrix}{d}_{1} \\ {d}_{2} \\ ⋮ \\ {d}_{K}\end{matrix} ] , K labels ,$$

where the target named entity spans [i,j] positions in the sentence X, G[i] represents the column of i-th word in label-word matrix, indicating the i-th-word relatedness with all the labels, r is the context window (i.e., the entity has a window from i−r to j+r), and αᵢ and φᵢ are parameters that can be manually configured. The equation shows a general form of summing up all of the words' relatedness to labels, given an input sentence.

D represents the relatedness of the given sentence with all the labels. With K labels, then D∈R^{K}. D can also be considered as a discrete distribution over all the labels. In one embodiment, the processor 110 uses entropy as a difficulty estimator, as follows:

$$Difficulty = Entropy ( D ) = \sum {d}_{i} log \frac{1}{{d}_{i}}$$

With a low entropy, D has a very certain distribution over the labels and the NER difficulty is accordingly low. Meanwhile, a high entropy means that D has even values on all the labels and it is not certain which label this sentence is more closely related to, and the NER difficulty of the sentence is accordingly higher. In one embodiment, the difficulty estimation is extended to be more general, by adding weight parameter δᵢ for each label, as follows:

$$Difficulty = Entropy ( D ) = \sum {δ}_{i} {d}_{i} log \frac{1}{{δ}_{i} {d}_{i}}$$

This weight parameter δᵢ indicates the different importance of the labels. With the adoption of δᵢ, different strategies can be developed for estimating difficulty. For example, entity type can be prioritized or boundary type can be prioritized. Meaning that instances for which it is easy to detect the boundary can be placed in the early phase for the training or instances for which it is easy to decide its entity types can be placed in the early phase. Thus, this technique provides better control over the NER model training to first build up its knowledge in entity boundary or first build up its knowledge in the entity type information.

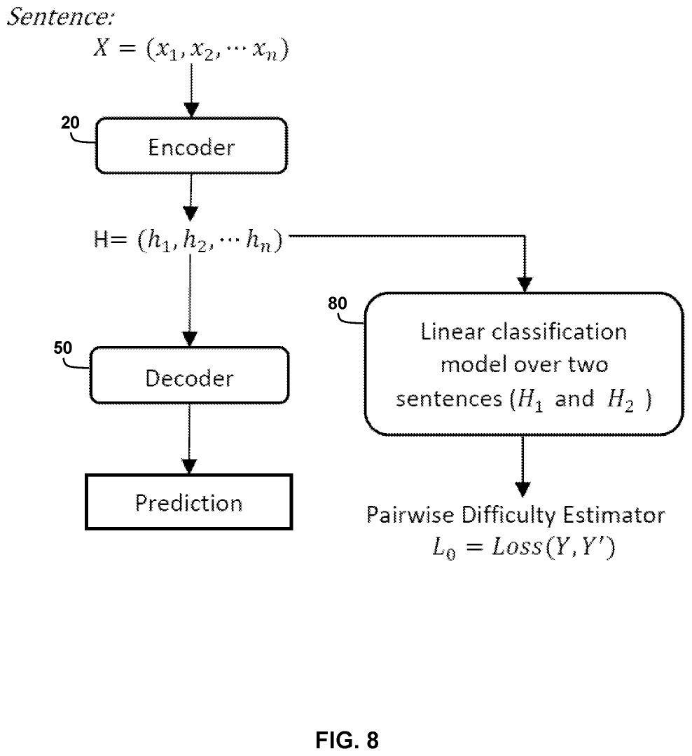

In addition to the above systematic approach, in some embodiments, annotators can be incorporated in the loop to annotate some labels by making pairwise comparisons over two entities of the same types, with each entity contained in its respective sentence. Moreover, FIG. 8 shows an approach in which a classification module 80 is provided to similarly make pairwise difficulty comparisons for the purpose of sorting out the difficulty of all training sentences X. The classification module 80 may, for example, perform a linear classification. The training of the classification module 80 could be performed prior to the encoder-decoder framework 10 training, or performed along with the encoder-decoder framework 10 training based on a pairwise difficulty training loss.

The processor 110 determines the scheduled sequence of training sentences X in a manner such that the sentences are organized into training batches. Each training batch has a respective ratio of (i) easy sentences, i.e., sentences having a relatively lower NER difficulty and (ii) difficult sentences, i.e., sentences having a relatively higher NER difficulty.

In some embodiments, the processor 110 controls the ratio of easy and difficult sentences in each batch of the training using a self-paced learning (SPL) approach. Particularly, the processor 110 sets the respective ratio for each training batch depending on a performance of the NER model with respect to a previous training batch.

In one embodiment, in the self-paced learning, the processor 110 uses a threshold parameter to control the number of difficult instances. Suppose vᵢ is the weight of the loss coming from i-th instance and λ is the threshold parameter. The self-paced learning minimizes the following total loss as follows:

$$min E ( v , λ ) = {\sum }_{1}^{N} {v}_{i} \cdot {L}_{i} - λ {\sum }_{1}^{N} {v}_{i} , 0 < {v}_{i} < 1.$$

With an ACS (Alternative Convex Search) approach, the processor 110 obtains the optimal v as follows:

$${v}_{i} = \{ \begin{matrix}1 & {L}_{i} < λ \\ 0 & otherwise\end{matrix}$$

This setting of vᵢ indicates that when the loss is smaller than certain value λ, that instance will be used for optimization, otherwise, the difficult instances will be used later.

As an extension of this SPL approach, in some embodiments, the processor 110 uses a Step-Increase Sampling SPL process (SIS-SPL). First, the processor 110 uses the previously determined NER difficulties of the training sentences X and samples a batch of the training sentences X from the easiest to most difficult. Then, the processor 110 feeds the sampled batch into the NER model to give a rough calculation of the loss value for these instances. Suppose the processor 110 is given a group of loss values (L₁, L₂, . . . , Lₙ) from the sampled batch. Next, suppose all the difficulties can be ranked into T levels. Then, the processor 110 equally segments the loss values into the T groups to arrive at T loss thresholds (λ₁, λ₂, . . . , λ_{T}).

In one embodiment, in the self-paced learning, the processor 110 uses two parameters, λₜᵣₐᵢₙ and λ_{well-train} to control the number of difficult instances. λₜᵣₐᵢₙ is similar to original self-paced learning parameter A mentioned above, which controls what instances can be put in the training, while λ_{well-train} is a threshold indicating that this instance has been well-trained, and that more difficult instances should be considered in following batches, as follows:

$${v}_{i} = \{ \begin{matrix}1 & {L}_{i} < {λ}_{train} \\ 0 & otherwise\end{matrix} \\ {λ}_{train} = \{ \begin{matrix}move to next level in ( {λ}_{1} , {λ}_{2} , … , {λ}_{T} ) & ratio ( {L}_{i} < {λ}_{well - train} ) \geq 0.8 \\ {λ}_{train} keep unchanged & otherwise\end{matrix} .$$

In summary, the processor 110 first samples from the training sentences to get a rough idea about possible value range of the training loss. Next, the processor 110 determines the ascending loss thresholds (λ₁, λ₂, . . . , λ_{T}) according to difficulty levels T. Finally, during training, the processor 110 increases the threshold λₜᵣₐᵢₙ step by step depending on whether the current batch has most instances well-trained according to the threshold λ_{well-train}.

Finally, it should be appreciated that, once the NER model has been trained, it can be used for performing NER on new sentences. Utilizing the trained model to perform NER on new sentences operates with a fundamentally similar process to the method 200. Accordingly, the process is not described again in complete detail. In summary, the processor 110 receives a new sentence and determines the text embedding H and attention vector β. The processor 110 determines the attended text embedding H′ and decodes it using the NER decoder 50 to arrive at token-level NER labels Y′. In this manner, the trained model can be used to perform NER on new sentences, after having been trained with a relatively small number of training inputs, as discussed above.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for training a model configured to perform a named entity recognition task, the method comprising:
receiving, with a processor, a sentence and ground truth labels as training inputs;
determining, with the processor, a text embedding representing the sentence using the model based on the sentence;
determining, with the processor, an attention vector using the model using the model based on the text embedding;
determining, with the processor, an attended text embedding using the model based on the text embedding and the attention vector;
determining, with the processor, named entity recognition labels for individual words of the sentence using the model based on the attended text embedding;
determining, with the processor, a first training loss based on the named entity recognition labels and the ground truth label data; and
refining, with the processor, the model using the first training loss.

2. The method according to claim 1, the determining the attention vector further comprising:
determining the attention vector based on the text embedding and a label-word relation matrix representing relations between respective words in a vocabulary and respective labels in a plurality of labels.

3. The method according to claim 2 further comprising:
generating, prior to training the model, the label-word relation matrix based on the vocabulary and the plurality of labels.

4. The method according to claim 3, the generating the label-word relation matrix further comprising:
determining a plurality of word embeddings representing all words in the vocabulary using the model;
determining a plurality of label embeddings representing all labels in the plurality of labels using the model; and
determining the label-word relation matrix based on the plurality of word embeddings and plurality of label embeddings.

5. The method according to claim 4, the generating the label-word relation matrix further comprising:
determining each element of the label-word relation matrix by determining a dot product of a respective word embedding from the plurality of word embeddings and a respective label embedding from the plurality of label embeddings.

6. The method according to claim 5, the generating the label-word relation matrix further comprising:
normalizing each element of the label-word relation matrix using a normalization operation.

7. The method according to claim 4, wherein the plurality of labels include:
compound labels each indicating both a named entity type and a label boundary;
decomposed entity labels indicating a named entity type; and
decomposed label boundaries indicating a label boundary.

8. The method according to claim 3, the generating the label-word relation matrix further comprising:
receiving a label-label relation matrix representing relations between respective labels in the plurality of labels and respective other labels in the plurality of labels;
receiving a word-word relation matrix representing relations between respective words in the vocabulary and respective other words in the vocabulary; and
augmenting the label-word relation matrix by multiplying the label-label relation matrix and the word-word relation matrix with the label-word relation matrix.

9. The method according to claim 8, wherein:
each element of the label-label relation matrix represents a similarity in meaning between a respective label from the plurality of labels and a respective other label from the plurality of labels; and
each element of the word-word relation matrix represents a similarity in meaning between a respective word from the vocabulary and a respective other word from the vocabulary.

10. The method according to claim 2, the determining the attention vector further comprising:
determining the attention vector as a sequence of attention values, each attention value in the attention vector corresponding to a respective word in the sentence and being determined based on a subset of elements in the label-word relation matrix representing relations between the respective word and the plurality of labels.

11. The method according to claim 10, the determining the attention vector further comprising:
determining each attention value in the attention vector based on an element in the label-word relation matrix representing a label in the plurality of labels that has a strongest relation with the respective word.

12. The method according to claim 10, the determining the attention vector further comprising:
determining the attention vector as a sequence of attention values, each corresponding to a respective word in the sentence, each attention value in the attention vector being determined based on a subset of elements in the label-word relation matrix representing (i) relations between the respective word and the plurality of labels and (ii) relations between at least one word adjacent to the respective word and the plurality of labels.

13. The method according to claim 12, the determining the attention vector further comprising at least one of:
weighting the subset of elements in the label-word relation matrix with a weight matrix; and
offsetting the subset of elements in the label-word relation matrix with an offset matrix.

14. The method according to claim 11, the determining the attention vector further comprising:
modifying the sequence of attention values in the attention vector depending on a pattern in the attention vector.

15. The method according to claim 14, wherein the pattern is positional relationship between (i) at least one first word in the sentence corresponding to attention values in the attention vector with respect to a particular label of the plurality of labels that exceed a predetermined threshold and (ii) at least one second word in the sentence corresponding to an entity that is to be labeled with the particular label.

16. The method according to claim 15, the modifying further comprising:
reducing the attention values in the attention vector corresponding to the at least one first word; and
increasing attention values in the attention vector corresponding to the at least one second word.

17. The method according to claim 1, the determining the attended text embedding further comprising:
determining the attended text embedding by multiplying the text embedding with the attention vector.

18. The method according to claim 2, wherein the sentence is one of a plurality of sentences, the method further comprising:
determining, with the processor, for each respective sentence in the plurality of sentences, a respective difficulty using the label-word relation matrix, each respective difficulty indicating a difficulty of performing a named entity recognition task with respect to the respective sentence;
scheduling, with the processor, the plurality of sentences into a sequence of sentences, using a curriculum learning technique in which sentences having a relatively lower named entity recognition difficulty are sequenced earlier than sentences having a relatively higher named entity recognition difficulty; and
feeding, with the processor, during training, the plurality of sentences into the model according to the scheduled sequence of sentences.

19. The method according to claim 18, wherein the sequence of sentences is organized into training batches, each training batch having a respective ratio of (i) sentences having a relatively lower difficulty and (ii) sentences having a relatively higher difficulty, the scheduling further comprising:
setting, the respective ratio for each training batch in sequence of sentences, depending on a performance of the model with respect to a previous training batch in the sequence of sentences.

20. The method according to claim 1 further comprising:
determining a classification label for the sentence as a whole using the model;
determining a second training loss based on the classification label and the ground truth label data; and
refining the model jointly using the first training loss and the second training loss.
